(19) United States
(12) Patent Application Publication
(10) Pub. No.: US 2017/0197535 A1
(43) Pub. Date: Jul. 13, 2017

(54) STABILIZED RECEPTACLE FOR USE IN VEHICLES

(71) Applicants: Phillip S. Eggers, Plano, TX (US); Scott T. Andersen, Council Bluffs, IA (US)

(72) Inventors: Phillip S. Eggers, Plano, TX (US); Scott T. Andersen, Council Bluffs, IA (US)

(21) Appl. No.: 14/994,051

(22) Filed: Jan. 12, 2016

(51) Int. Cl. B60N 3/08; B65F 1/02; B65D 25/24; B65F 1/16; B60R 7/02; B65D 25/28

(52) U.S. Cl. CPC B60N 3/08; B60R 7/02; B65D 25/2805; B65D 25/24; B65F 1/1646; B65F 1/02; B65F 2001/1653

(57) ABSTRACT

A stabilized container having a rectangular top, a four-sided rectangular middle section supported by four corner columns and a corrugated base having a sealed compartment and separate mating compartments for the four corner columns.

### TECHNICAL FIELD

The present disclosure relates generally to containers, and more specifically to a stablized receptacle for use in vehicles.

### BACKGROUND OF THE INVENTION

Containers for use in vehicles typically are configured to attach to a surface, such as by adhesives or using a mechanical attachment.

### SUMMARY OF THE INVENTION

A stabilized container is disclosed that has a rectangular top, a four-sided rectangular middle section supported by four corner columns and a corrugated base having a sealed compartment and separate mating compartments for the four corner columns. The stabilized container is adapted for use within a vehicle, and can contain debris or other contents without spillage during operation of the vehicle, such as when driving over rough roads or when accelerating or stopping.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of an isometric view of a stabilized receptacle for use in a vehicle, in accordance with an exemplary embodiment of the present disclosure;

FIG. 2 is a diagram of a front view of a stabilized receptacle for use in a vehicle, in accordance with an exemplary embodiment of the present disclosure;

FIG. 3 is a diagram of a rear view of a stabilized receptacle for use in a vehicle, in accordance with an exemplary embodiment of the present disclosure;

FIG. 4 is a diagram of a side view of a stabilized receptacle for use in a vehicle, in accordance with an exemplary embodiment of the present disclosure;

FIG. 5 is a diagram of a top view of a stabilized receptacle for use in a vehicle, in accordance with an exemplary embodiment of the present disclosure; and

FIG. 6 is a diagram of a bottom view of a stabilized receptacle for use in a vehicle, in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

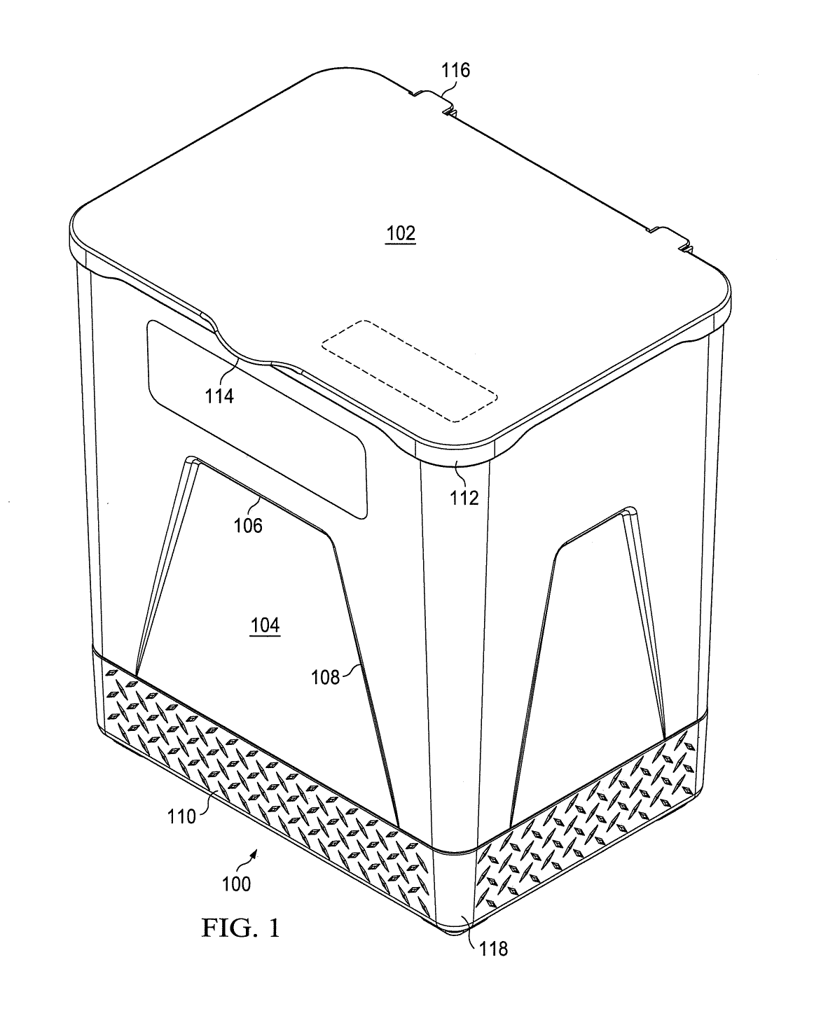

FIG. 1 is a diagram 100 of an isometric view of a stabilized receptacle for use in a vehicle, in accordance with an exemplary embodiment of the present disclosure. The stabilized receptacle shown in diagram 100 includes both functional and ornamental aspects, but only the functional aspects are the subject the inventions as claimed herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Diagram 100 includes top 102, which is secured to middle section middle section 104104 by clasp 114, hinges 116 or other suitable structures. In one exemplary embodiment, top 102 can include four contoured corners 112, each of which follow the contour of a corner column 118. Top 102 can be formed by compression molding, injection molding, metalworking or in other suitable manners. Corner column 118 provides additional structural stability, suitable for use within an environment such as a vehicle, where the stabilized receptacle can be exposed to sliding, side impacts, being overturned and other rough handling. The use of four corner columns also creates a recessed area between the columns that helps to center the contents and prevent the weight of the contents of the container from accumulating on a single side, which can result in an offset center of gravity and increased likelihood of tipping over. Likewise, top 102 can have a reinforced clasp that secures top 102 onto middle section 104, to prevent top 102 from inadvertently opening and spilling the contents of the stabilized receptacle. Top 102 can also or alternatively be fitted to middle section 104, so as to form a seal around the perimeter of base 104 where top 102 interfaces with middle section 104. Middle section 104 can be formed by compression molding, injection molding, metalworking or in other suitable manners.

Middle section 104 includes contoured handles 106, which include structural supports 108, and corrugated base 110, which includes an interior compartment (not explicitly shown) for holding sand or other weighting material. Handles 106 and structural supports 108 can form a recessed volume that can be increased in size in order to provide additional stability to the stabilized receptacle, between the corner column supports. For example, the recessed volume can be a predetermined fraction of the total volume of the stabilized receptacle, such as 10% of the total volume for light homogenous materials, 40% of the total volume for materials that are not homogenous and which can have heavy components, or other suitable volumes. Corrugated base 110 can be formed by injection molding, metalworking or in other suitable manners. The interior compartment of corrugated base 110 can be sized as a function of the type of contents of the stabilized receptacle, such as to provide for an increased amount of weighting material when the intended use will include containing heavy debris, such as metal refuse, to provide for less weighting material when the intended use is to contain paper debris, and so forth. Middle section 104 can be formed from metal, polymer or other suitable durable materials, and corrugated base 110 can be formed from a continuous or separate material, such as the same or different type of polymer or metal. Although the described components are functional, they include ornamental aspects such as those pertaining solely to the appearance of the stabilized receptacle. For example, the height, width and length dimensions, the angle of structural supports 108, the exterior shape of corner columns 118, the edge contour detail of top 102, the shape of clasp 114 and other ornamental features are disclosed but not claimed.

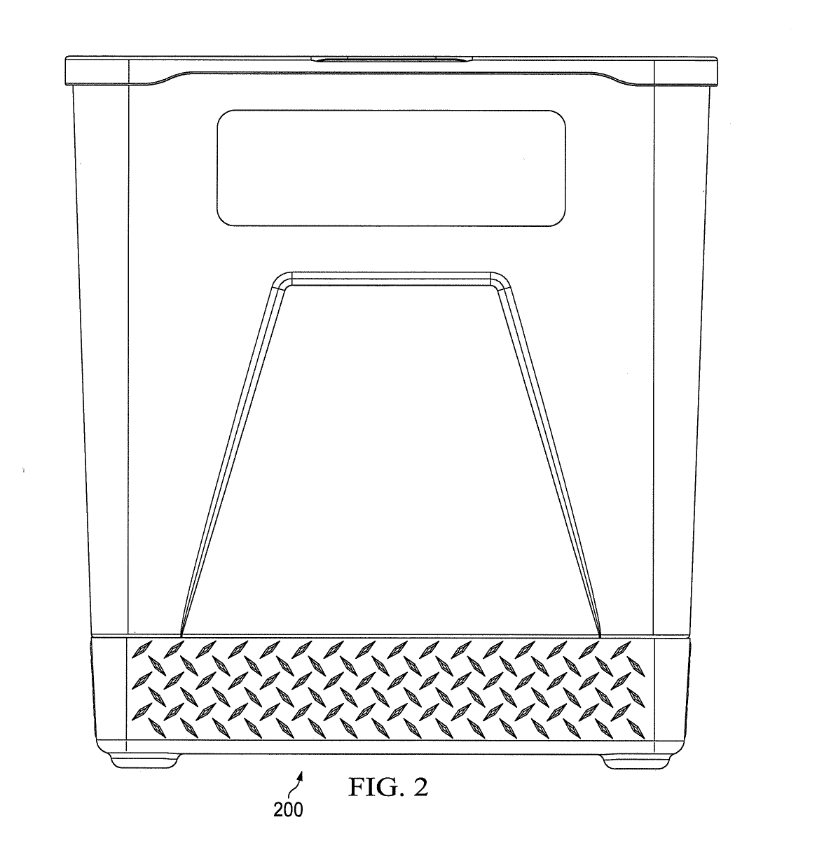

FIG. 2 is a diagram 200 of a front view of a stabilized receptacle for use in a vehicle, in accordance with an exemplary embodiment of the present disclosure. Diagram 200 includes feet 202, which can be formed integral with corner columns 118, in order to provide additional structural stability, or in other suitable manners.

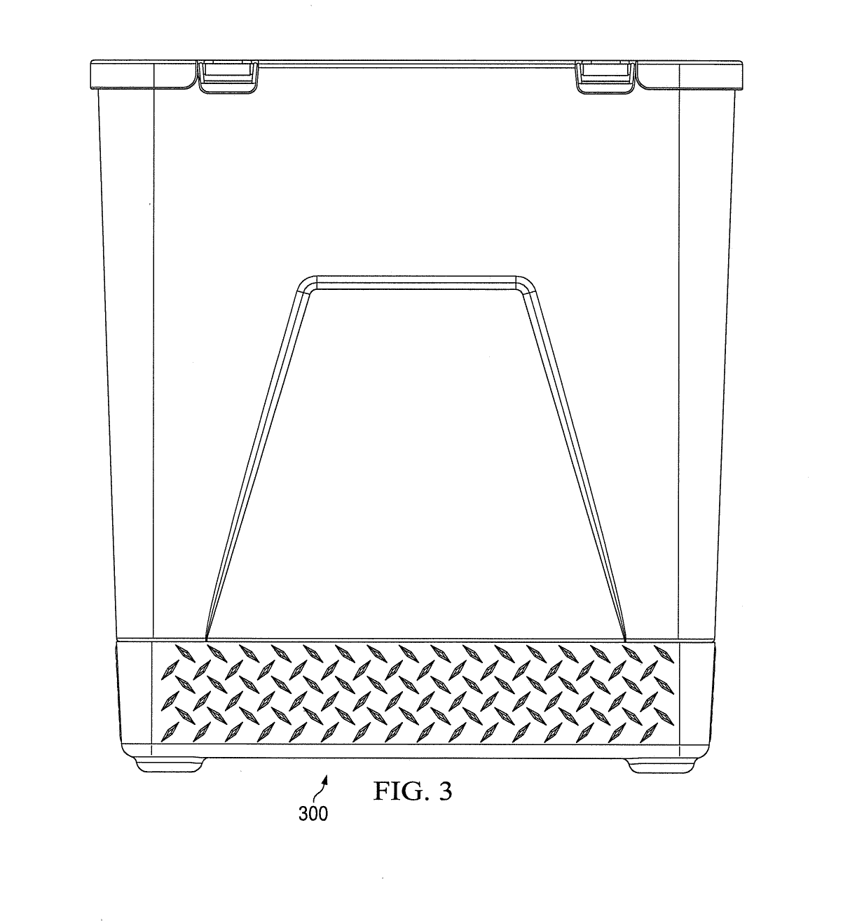

FIG. 3 is a diagram 300 of a rear view of a stabilized receptacle for use in a vehicle, in accordance with an exemplary embodiment of the present disclosure. Diagram 300 shows where hinges 116 connect to middle section 104, as well as other functional and ornamental aspects of the stabilized receptacle.

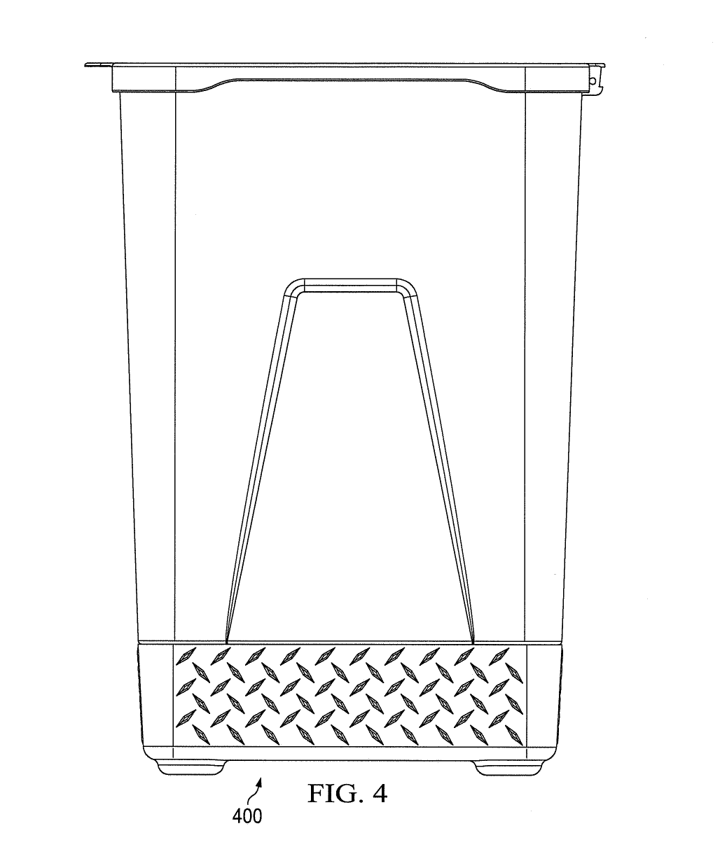

FIG. 4 is a diagram 400 of a side view of a stabilized receptacle for use in a vehicle, in accordance with an exemplary embodiment of the present disclosure. While the functional features such as contoured handles 106 and structural supports 108 are included on the sides, the ornamental features are varied from the appearance of the ornamental features of the front and back sides, such as the width and height ratios and angles of supports 108 relative to the top and sides.

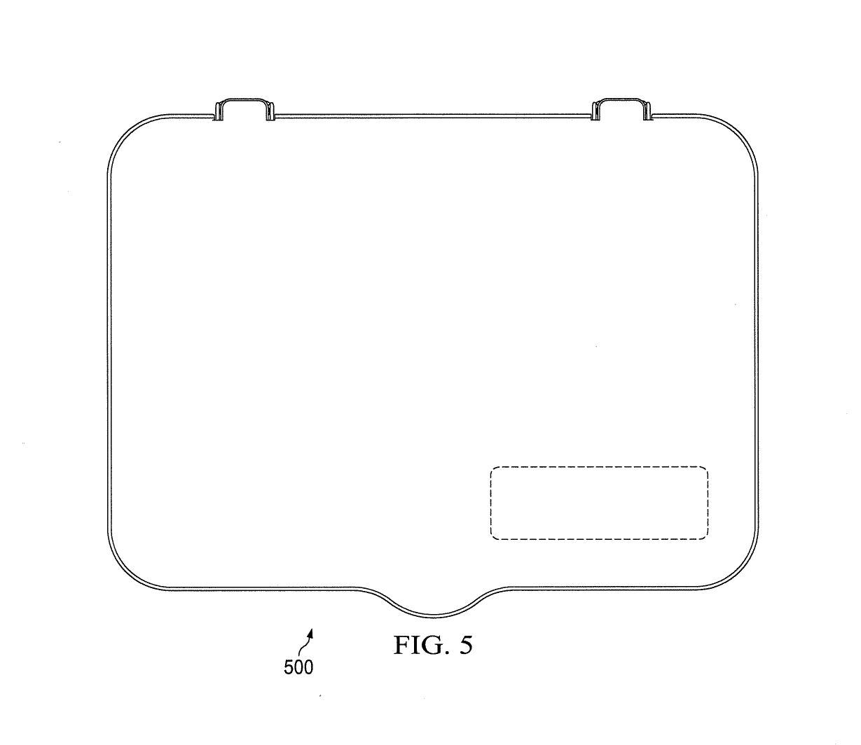

FIG. 5 is a diagram 500 of a top view of a stabilized receptacle for use in a vehicle, in accordance with an exemplary embodiment of the present disclosure.

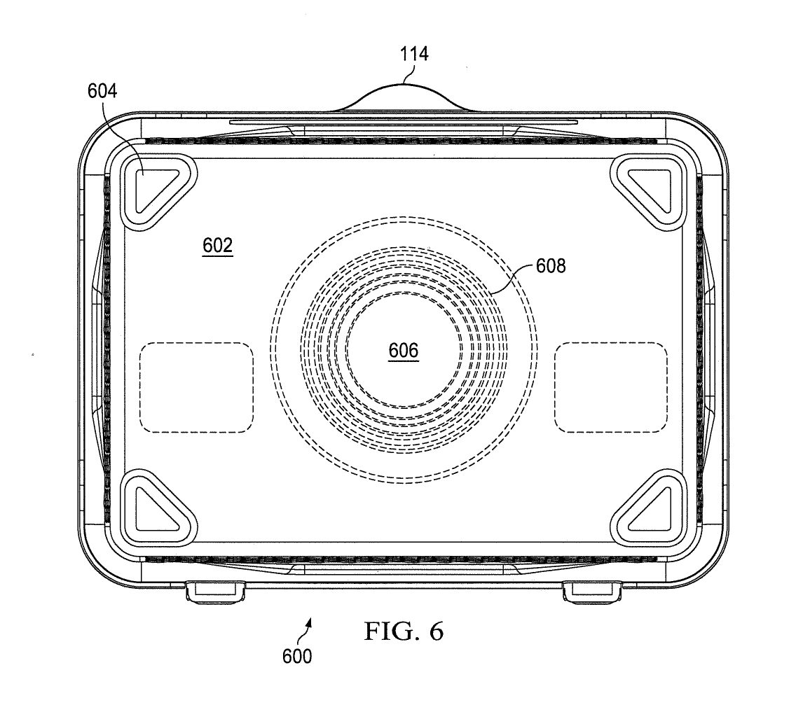

FIG. 6 is a diagram 600 of a bottom view of a stabilized receptacle for use in a vehicle, in accordance with an exemplary embodiment of the present disclosure. Diagram 600 includes fill cap 606, which is secured to port 608 by threads or other suitable mechanisms. Feet 604 are disposed at each corner of the base.

In operation, fill cap 606 is removed from port 608 to allow the interior compartment of corrugated base 110 to be filled with sand or other suitable weighting materials. Fill cap 606 is then secured to port 608 and the stabilized receptacle is placed in a suitable location within the vehicle.

The stabilized receptacle can be formed by constructing corrugated base 110 separately from middle section 104 and top 102. The corner columns of middle section 104 can then be inserted into suitable mating compartments in corrugated middle section 104, and hinges 116 can be used to attach top 102 to middle section 104.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A stabilized container, comprising:
a rectangular top;
a four-sided rectangular middle section supported by four corner columns and coupled to the rectangular top and having a recessed area between each corner column with a predetermined volume as a percentage of the total volume of the stabilized container, to improve stability of the stabilized container;
a corrugated base having a sealed compartment and separate mating compartments for the four corner columns and coupled to the four-sided rectangular middle section.

2. The stabilized container of claim 1 wherein the rectangular top further comprises a clasp mechanism configured to support a predetermined force applied against the rectangular top by contents of the stabilized container.

3. The stabilized container of claim 1 further comprising a plurality of handles set into two or more sides of the four-sided rectangular middle section, each handle further comprising one or more structural supports configured to provide structural support for a side of the stabilized container.

4. The stabilized container of claim 1 wherein the corrugated base further comprises a removable fill cap.

5. The stabilized container of claim 1 wherein the corrugated base further comprises a plurality of feet supports.

6. The stabilized container of claim 1 wherein the corrugated base further comprises a plurality of feet supports, each aligned with one of the corner columns.

7. The stabilized container of claim 1 wherein the rectangular top further comprises mating seals at each corner that are each configured to seal with one of the associated corner columns.

8. A method of manufacturing a stabilized container, comprising:
forming a rectangular top;
forming a four-sided rectangular middle section supported by four corner columns in parallel with the manufacturing of the rectangular top;
forming a corrugated base having a sealed compartment and separate mating compartments for the four corner columns in parallel with the manufacturing of the rectangular top and the four-sided rectangular base;
assembling the four-sided rectangular middle section onto the corrugated base; and
assembling the rectangular top onto the four-sided rectangular middle section.

9. The method of claim 8 wherein forming the rectangular top further comprises assembling a clasp mechanism configured to support a predetermined force applied against the rectangular top by contents of the stabilized container.

10. The method of claim 8 further comprising forming a plurality of handles set into two or more sides of the four-sided rectangular middle section, each handle further comprising one or more structural supports configured to provide structural support for a side of the stabilized container.

11. The method of claim 8 wherein forming the corrugated base further comprises forming a removable fill cap in the corrugated base.

12. The method of claim 8 wherein forming the corrugated base further comprises forming a plurality of feet supports in the corrugated base.

13. The method of claim 8 wherein forming the corrugated base further comprises forming a plurality of feet supports on the corrugated base, each foot support aligned with one of the corner columns.

14. The method of claim 8 wherein forming the rectangular top further comprises forming mating seals at each corner of the rectangular top that are each configured to seal with one of the associated corner columns.

15. A method of manufacturing a stabilized container having a rectangular top, a four-sided rectangular middle section supported by four corner columns, a corrugated base having a sealed compartment and separate mating compartments for the four corner columns, wherein the rectangular top further comprises a clasp mechanism configured to support a predetermined force applied against the rectangular top by contents of the stabilized container, a plurality of handles set into two or more sides of the four-sided rectangular middle section, each handle further comprising one or more structural supports configured to provide structural support for a side of the stabilized container, a removable fill cap, a plurality of feet supports, each aligned with one of the corner columns, and mating seals at each corner that are each configured to seal with one of the associated corner columns, the method comprising:
forming the rectangular top;
forming the four-sided rectangular middle section supported by the four corner columns in parallel with the manufacturing of the rectangular top;
forming the corrugated base having the sealed compartment and separate mating compartments for the four corner columns in parallel with the manufacturing of the rectangular top and the four-sided rectangular middle section;
assembling the four-sided rectangular middle section onto the corrugated base;
assembling the rectangular top onto the four-sided rectangular middle section;
wherein forming the rectangular top further comprises assembling a clasp mechanism configured to support a predetermined force applied against the rectangular top by contents of the stabilized container;
forming a plurality of handles set into two or more sides of the four-sided rectangular middle section, each handle further comprising one or more structural supports configured to provide structural support for a side of the stabilized container;
forming a removable fill cap in the corrugated base;
forming a plurality of feet supports in the corrugated base;
forming a plurality of feet supports on the corrugated base, each foot support aligned with one of the corner columns; and
forming mating seals at each corner of the rectangular top that are each configured to seal with one of the associated corner columns.
